(19) United States
(12) Patent Application Publication
(10) Pub. No.: US 2022/0379307 A1
(43) Pub. Date: Dec. 1, 2022

(54) System and Process for Handling a Fluid Volume and Transferring said Volume into a Microfluidic System

(71) Applicant: Robert Bosch GmbH, Stuttgart (DE)

(72) Inventors: Martina Budde, Karlsruhe (DE); Hannah Bott, Straubenhardt (DE); Aaron Doerr, Bietigheim-Bissingen (DE); Eva Weimer, Gaeufelen-Oeschelbronn (DE)

(21) Appl. No.: 17/764,901

(22) PCT Filed: Sep. 15, 2020
(86) PCT No.: PCT/EP2020/075723

§ 371 Date: Mar. 29, 2022

(30) Foreign Application Priority Data
Sep. 30, 2019 (DE) 10 2019 215 030.6

(51) Int. Cl. B01L 3/00

(52) U.S. Cl. CPC B01L 3/502715; B01L 2200/027; B01L 2300/0681; B01L 3/5027; B01L 2300/044; B01L 2200/0631

(57) ABSTRACT

A system for transferring a sample into a microfluidic system, including a sample loading chamber, wherein a first sub-volume of the sample loading chamber is separated from at least one second sub-volume of the sample loading chamber by a filter module. The first sub-volume forms a pressure chamber provided for the loading of the sample, and there is at least one second sub-volume for providing the microfluidic system with the sample.

The invention relates to a device for a microfluidic system and to a method for handling a fluid volume.

### PRIOR ART

Microfluidic systems allow the analysis of small amounts of samples with great sensitivity. The automation, miniaturization and parallelization of the processes also allow a reduction of manual steps, and a decrease in the errors caused as a result.

Microfluidic systems are intended to make possible a “point-of-care analysis” of samples. A “point-of-care analysis” is a rapid sample analysis which makes do without complicated and time-intensive work steps, in particular without work steps that would have to be performed by trained personnel in central laboratories. This can be realized by a microfluidically based lab-on-chip (LoC) system. Here it is desirable to design the so-called ‘World-to-Chip Interface’ in such a way that the sample can be transferred onto the chip, that is to say into the microfluidic system, in a simple process that is not prone to error.

LoC systems are used for various applications. In a network system of channels and chambers on a microfluidic basis, located in a so-called LoC cartridge, the various problems can be tackled and different sequences programmed. The possible applications of an LoC system differ in the ‘on-chip’ sequences and processes, but also in the taking and preparational treatment of samples in the ‘macro world’. There is a special focus on the conceptualization of an LoC system, in particular on the input chamber of the chip, the so-called ‘World-to-Chip Interface’. This should make it possible for various types of samples to be taken up and processed without losses on a universally usable system designed for many applications.

### DISCLOSURE OF THE INVENTION

It is intended to describe here microfluidic systems with a sample input chamber of a novel design, which offers particularly advantageous possibilities of sample processing.

The device described here is preferably part of a cartridge, which is typically an LoC cartridge and, apart from the described device, also has a microfluidic system.

The device comprises a sample input chamber for the input of a sample, wherein the sample input chamber can be divided by a filter module at least into a first sub-volume and a second sub-volume, wherein the first sub-volume forms a pressure chamber, which is intended for the input of the sample, and the second sub-volume is intended for presenting the sample to the microfluidic system, wherein the second sub-volume has at least one outlet, which connects the second sub-volume to the microfluidic system. A pressure chamber should be understood as meaning in particular a chamber which is sealed in a fluid-tight manner in such a way that a pressure exceeding the pressure outside the chamber can be set in the chamber. For this purpose, the chamber may be sealed in a fluid-tight manner. The chamber preferably allows an input of a sample without fluid being able to escape from the chamber. For example, the chamber comprises for this purpose a pierceable membrane, in particular a septum, or a valve, which is only flowed through by fluid in one direction, such as for example a check valve.

Typical types of samples are for example samples of the following substances and/or matter:
blood,
urine,
mucosal smears,
a stool sample, or
samples consisting of the aforementioned substances and/or matter, possibly diluted with carrier fluids.

It is intended here firstly to give a description of the fundamental aspects of the sample input chamber or its structure. Typically, the entire sample input chamber has a volume of between 0.1 ml [milliliters] and 10 ml. The sample input chamber preferably has a cross-sectional area of between 1 mm² [square millimeters] and 2500 mm² and a depth of between 5 mm [millimeters] and 50 mm. The sample input chamber is divided by the filter into the described sub-volumes, so that the sub-volumes are in each case correspondingly smaller than the sample input chamber as a whole.

The key component of the disclosure described here is the sample input chamber, which may also be referred to as a World-to-Chip interface. This sample input chamber forms a kind of interface between the macroscopic “world”, in which the sample is transferred into the microfluidic system, and the microfluidic system for the processing of the sample.

The sample input chamber of the microfluidic system is configured with a volume v, which is divided by the filter module or the filter structures of the filter module into at least two sub-volumes, to be specific into a first sub-volume v₁ and a second sub-volume v₂.

The microfluidic system can be designed very flexibly. Usually, it comprises multiple channels and/or further chambers, in which the reactions and the analysis for which the microfluidic system is intended are carried out. It may also be for example a multiplicity of chambers created in the form of an array, in which a multiplicity of different analysis steps can be carried out in parallel. If appropriate, further reservoirs for reagents, pumping elements, valves etc. may also be part of the LoC cartridge.

Furthermore, the described structure of an LoC cartridge with the described device and the method for sample input also described below already allow an active filtration or separation step for sample preparation to take place without microfluidic operations already having to be carried out by active microfluidic elements such as micro pumps or valves, that is to say these steps can take place outside the microfluidic system but already within the LoC cartridge of the lab-on-chip system.

The first sub-volume is preferably chosen to be smaller than the sample volume of the sample to be processed, in order to ensure the transfer of the sample material from v₁ to v₂. It is particularly advantageous if the first sub-volume is adapted to the nature of the sample, for example the expected particle content intended to be held back.

The second sub-volume is preferably located between the outlet of the sample input chamber and the filter module. Particularly preferably, it is arranged under the first sub-volume with respect to the geodetic alignment of the microfluidic system during its use.

It is particularly advantageous if the sample input chamber has an input opening, which is sealed with respect to the surroundings by a fluid-tight cover structure, wherein the fluid-tight cover structure can be severed by an input means for the input of the sample in such a way that contamination-free input of the sample into the sample input chamber takes place.

It is also advantageous if the fluid-tight cover structure is configured such that a pressure can be built up in the first sub-volume by an input means.

The cover structure may be configured as a kind of artificial “septum”. An artificial septum is preferably an elastic membrane which can be pierced through by a cannula, wherein a fluid-tight seal of the opening of the sample input chamber always remains ensured. Preferably, a hole which is created when the septum is pierced with the cannula immediately closes itself again in a fluid-tight manner when the cannula is removed again. As long as the cannula remains pierced through the septum, a fluid-tight seal of the cannula at the septum exists.

With the aid of a cover structure configured in such a way, and the sealing thereby achieved with respect to the surroundings, contamination-free filling of the chamber with the sample is made possible.

An input means for the input of the sample preferably comprises the described cannula and particularly preferably also a means for building up pressure, for example a syringe. The input means may for example be a syringe or pipette with a cannula. The sample with the volume vp is introduced, for example with a cannula, into the upper part of the sample-specific chamber with the volume v₁. As soon as the volume v₁ is completely filled with sample, when further sample is supplied the added volume is transported through the filter module into the second sub-volume.

The input means can be used to build up a pressure which propagates into the first sub-volume (forming the pressure chamber). This pressure can be used to feed or force the sample through the filter module. The cover structure is configured so as to withstand this pressure, and so no decrease in the pressure takes place through the input opening.

The manual input of the sample allows the exertion of much higher forces or pressures for the filtration of the sample in comparison with processing in classic microfluidic systems and/or cartridges and, in combination with a suitable membrane or a suitable filter or a suitable mesh in the filter module, sample materials which would not be processable in the microfluidic system without this preliminary step can thus be prepared and rendered usable for the LoC system. In particular, a filtration step before the intake of the sample into the microfluidic channel system, and as a result the avoidance of clogging of the fluidic network, is made possible by the described sample input chamber.

The filter module may be of a multilayered configuration.

The filter module may comprise one or more membranes, which are provided within the microfluidic, sample-specific chamber and which have for example a prefiltering or homogenizing function in order to increase the variety of analyzable sample input materials and biological assays.

When the sample transfers through the filter module into the second sub-volume, depending on the structure of the filter module with a membrane, a filter and/or a mesh, a filtering, mixing or shearing of the sample takes place. For example, contaminants of a certain size may be removed, the selective binding of proteins may be realized or the sample may be homogenized by mechanical shearing.

It is also preferred if the filter module is of an exchangeable design.

The filter module is preferably a component which is detached from the further microfluidic system and is used in the course of the production process. The further microfluidic system (all of the components of the system apart from the filter module) is preferably first produced (for example by an injection-molding process). Then the filter module is inserted. The filter module may for example also be adhesively bonded in the microfluidic system. The filter module may also be subsequently exchangeable, for example if it has a frame and the filter module or its frame is inserted in grooves and/or rails in the sample input chamber. The different filter modules allow otherwise identical microfluidic systems to be individualized for different kinds of samples.

With the aid of the described system, depending on the nature of the sample and desired target state, corresponding membranes or filters or meshes can be combined in a modular manner and arranged in series, and thus for example a “gradient size filtration” can be realized. Microfluidic systems of the type described may be of a uniform design apart from the filter module. By choosing the suitable filter module, a very good adaptation of the sample input chamber can be made for the desired use of the microfluidic system. This corresponds to a kind of specific adjustment of the sample input chamber for certain uses.

It is also preferred if the filter module is inserted in a receiving means in the sample input chamber.

Such a receiving means may be for example a groove and/or a notch or a shoulder in or on the sample input chamber, on which the filter module rests.

In configurational variants, a further insertable module, which if appropriate may also be connected to the filter module, may also be inserted in the sample input chamber.

Such a further insertable module may be for example a mixing module, which serves for mixing or homogenizing the sample.

It is also preferred if the sample input chamber has an inlet through which a fluid can be fed into the sample input chamber.

The second sub-volume v₂ or the lower part of the sample chamber is preferably in contact with the lab-on-chip cartridge on at least two sides by way of microfluidic channels, to be specific with at least one inlet and at least one outlet.

The at least one inlet is preferably separated from the sample input chamber by an inlet filter.

The inlet may be connected to further channels and/or chambers of the microfluidic system, in order to feed components/fluids from the microfluidic system back into the sample input chamber or into the second sub-volume. The inlet may also have a connection to which external components can be connected, for example a storage reservoir for a processing fluid which is intended to be mixed with the sample.

Particularly preferably, the device has a connecting line to the sample input chamber, by way of which a circulation can take place from the at least one outlet to the at least one inlet. The connecting line may open out both into v₁ and into v₂.

In an inlet (or if need be at multiple access points), an additional porous/mesh-like structure may be interposed if need be, ensuring further pre-treatment of the sample (for example renewed filtering and/or homogenization).

It is also intended to describe here a method for using a described device, wherein an input of a sample into the sample input chamber takes place, wherein the sample volume of the sample is greater than the first sub-volume.

The advantages and design features described for the described device can be applied and transferred to the described method, and vice versa.

The fact that the sample volume is greater than the first sub-volume also has the effect of ensuring that the sample volume passes through the filter module and enters the second sub-volume, and consequently also enters the processing unit of the microfluidic system.

It is particularly advantageous if a sample sub-volume of the sample is fed through the filter module into the second sub-volume of the sample input chamber.

This takes place in particular by the first sub-volume acting as a pressure chamber and the sample volume being greater than the first sub-volume. The size of the sample sub-volume consequently corresponds (approximately) to the sample volume minus the first sub-volume.

The method is also advantageous if, after the sample sub-volume passes through the filter module, a preparational treatment of the sample sub-volume for further processing in the microfluidic system takes place.

Such preparational treatment may for example comprise the following (sub)steps:
mixing of the sample,
shearing of the sample,
filtering of the sample,
chemical treatment of the sample, etc.

The method is also advantageous if, when the sample is input by the input means, a pressure greater than a maximum working pressure that can be provided by an automatable feeding means for the microfluidic system or on the cartridge is provided.

By this configurational variant it is potentially also possible to reduce the size of a feeding means of the microfluidic system or the cartridge, or directly make it of a smaller design, because the necessary pressure for filtering the sample with the filter module does not have to be built up by this feeding module.

The microfluidic system described here and methods made possible by this microfluidic system provide the following advantages:
1) The described device can be used on an already existing LoC platform. This provides further fluidic possibilities, which extend both the portfolio of usable sample materials and possible implementable assays. The essence of the fluidics does not have to be adapted for this.
2) The sample-specific device according to the invention can be realized by an insert in the sample input chamber or directly in the injection-molded part.
3) By sealing the upper sub-volume v₁, for example by means of a septum, the volume can be sealed from the surroundings and also allows contamination-free filling with the sample by means of a syringe.
4) Furthermore, the volume sealed by the septum has the effect that, after complete filling of the sub-volume v₁, when further sample is supplied the passage of the sample through the first membrane/filter/mesh is induced. Consequently, a (pre)filtration takes place directly during the manual sample input.
5) The sealing of the sample input chamber by means of a septum and the manual introduction of the sample by means of input means (cannula, syringe, etc.) achieves mechanical sample input and preparation on the microfluidic system. A manual step by means of a syringe within the sample input allows a higher pressure to be generated than in a purely microfluidic system, and thus makes possible the use of further sample materials.
6) The active filtration or separation step during the manual sample input has the effect that the processing of the sample is already started before the chip is introduced into the processing unit of the lab-on-chip system, that is to say before microfluidic operations can be carried out by active microfluidic elements such as micro pumps or valves. As a result, the time requirement for the overall process is reduced, which leads to a reduced risk of breakdown of fragile sample material and a quicker result.
7) A modularly exchangeable filter insert makes it possible to use a filter/membrane/mesh adapted to the nature of the initial samples, for example with respect to the particle sizes and/or binding properties.
8) The possible exchange of the filter membranes and resultant variation in the structure size allows the system to be designed for different sample materials and applications.
9) In addition, it is also possible for multiple filter membranes/meshes to be combined in the described device, or arranged one behind the other, and in this way sequential filtration can be made possible.
10) The contacting of the described sample-specific sample input chamber with the microfluidic system on a cartridge by way of at least two microfluidic channels (inlet and outlet) allows the mechanical sample preparation step to be brought into connection with the microfluidic system and the input liquid to be drawn into the cartridge, allowing circulatory pumping and consequently a mixing process to be achieved.
11) It is also possible by the described processes and methods to transport reagents provided in advance on the LoC cartridge to be transported into the sample input chamber.
12) A porous structure that can be used in a modular manner in the form of the filter module (filter/membrane/mesh) at the microfluidic input (or multiple inputs) of the chamber makes it possible to further process the circulatorily pumped liquid. Apart from renewed filtering, for example for realizing gradient-size filtration or selective binding of certain constituents, it is also possible by choosing a suitable filter insert to homogenize the sample. By pressing the constituents through small openings in a sieve-like membrane, larger sample constituents, for example cell clumps, can be individually separated.
13) The possible exchange of the membrane allows its function to be varied and as a result for example the degree of homogenization of the sample and/or filtration mechanism to be set. This increases the number of processable sample starting materials and assays that can be implemented in the LoC system.
14) By combining various functions in one component, different steps of an assay can also be made possible and combined in the described method.

The microfluidic system and the technical environment are explained in more detail below. The figures relate to particularly preferred exemplary embodiments. In the figures:

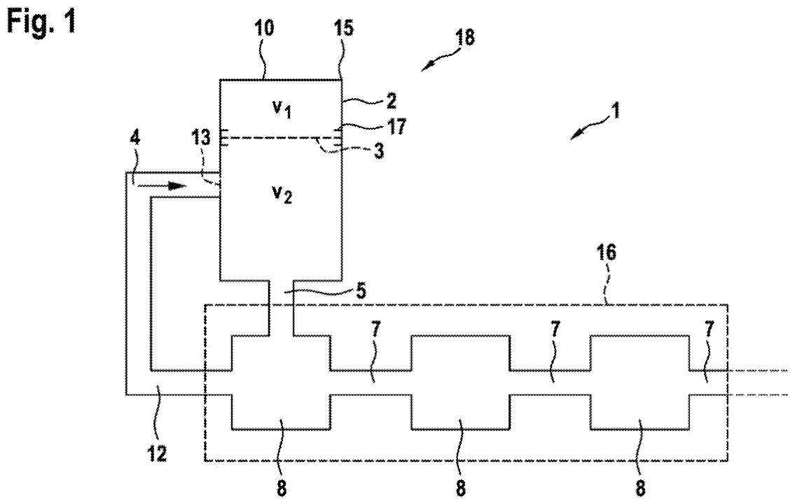

FIG. 1 shows a schematic structure of the described device on a cartridge

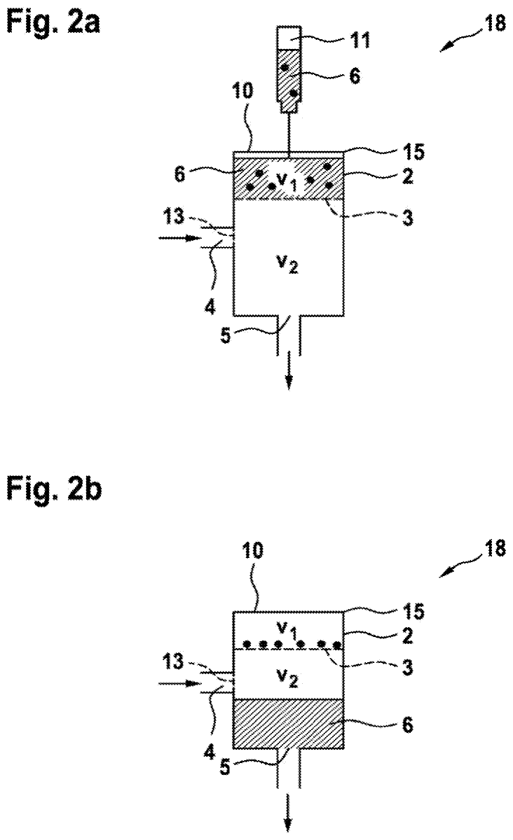

FIG. 2a and FIG. 2b show by way of example a first procedure for the input of a sample into the described device

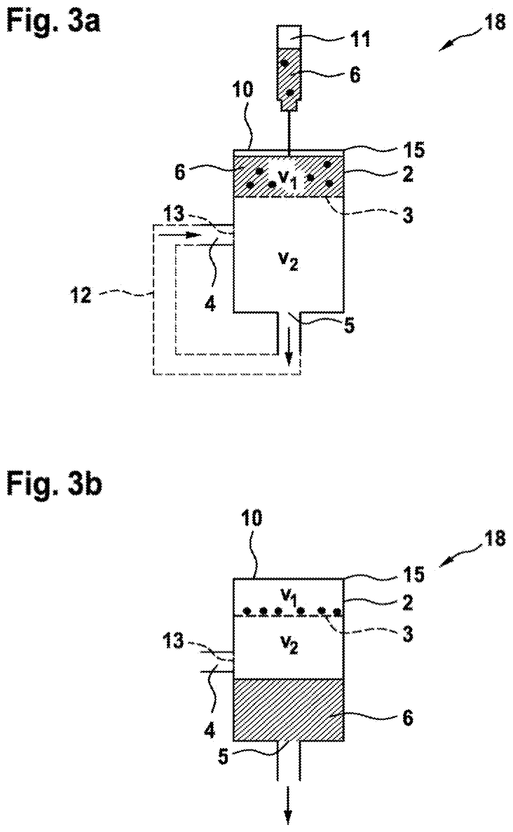

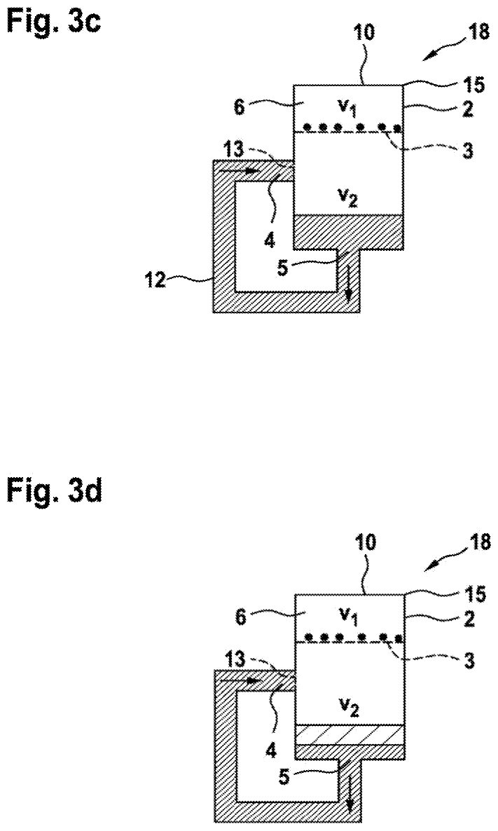

FIGS. 3a to 3d show by way of example a second procedure for the input of a sample into the described device

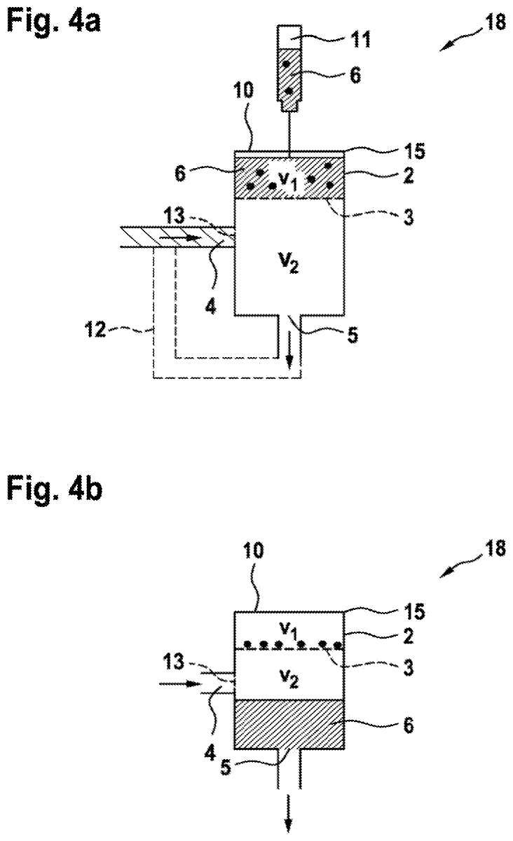

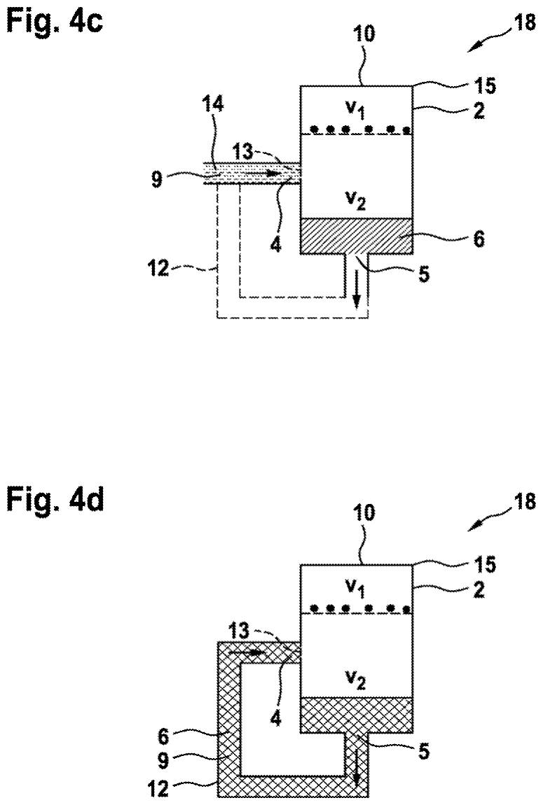

FIGS. 4a to 4d show by way of example a third procedure for the input of a sample into the described device.

FIG. 1 shows the basic concept of the proposed device 18 with a sample input chamber 2 for a cartridge 1. It can be seen that, apart from the device 18 with the sample input chamber 2, the cartridge 1 also comprises the microfluidic system 16, in which the actual analysis steps that can be carried out with the microfluidic system 16 are carried out. The microfluidic system 16 may comprise a multiplicity of further channels 7 and further chambers 8, which are respectively shown here by way of example. The overall volume of the sample input chamber 2 is divided into a first sub-volume v₁ and a second sub-volume v₂. The two sub-volumes v₁ and v₂ are separated from one another by an (exchangeable) filter module 3, which is inserted in a receiving means 17. The sample (not shown here) is introduced into the sample input chamber 2 by means of input means 11 (likewise not shown here), for example by means of a syringe, through the cover structure 10. The cover structure 10 may be a pierceable membrane (septum), which seals an input opening 15. The sample is in this case first introduced into the first sub-volume v₁. The cover structure 10 of such a configuration ensures contamination-free filling of the sample input chamber 2 and also shielding of the sample 6 with respect to the outside. The sample 6 passes from the second sub-volume v₂ into the microfluidic system through the outlet 5 of the sample input chamber 2, which adjoins the second sub-volume v₂. Here it is also shown by way of example that the sample input chamber 2 has an inlet 4, which is provided with an inlet filter 13 and which opens out into the sample input chamber 2 or in particular into the second sub-volume v₂ of the sample input chamber 2. The inlet 4 may be connected to a connecting line 12, which is likewise connected to the outlet 5 and which makes possible a circulation out of the sample input chamber 2 and back into the sample input chamber 2.

As a result of introducing the sample 6 by means of input means 11 without the need for microfluidic pumping functions, a mechanical sample preparation module is fitted onto the microfluidic system 16 of a cartridge 1. The sample preparation module is formed here by the sample input chamber 2 in combination with the filter module 3. The filter module 3 (modularly exchangeable filter membrane) makes possible the implementation of various functions. By way of the two access points (inlet and outlet 5), a reagent (the sample and/or further fluids 9) can be transferred into the microfluidic system 16 (shown here) of the cartridge 1. Since the inlet 4 and the outlet 5 are connected to one another by way of a connecting line 12, circulatory pumping of fluids 9 in the sample input chamber 2 is also possible. A further membrane at the inlet 4 and the outlet 5 (shown here by way of example is an inlet filter 13 at the inlet 4) allows the sample to be further processed after the first preliminary treatment. In particular, it is possible to filter, bind or else homogenize the sample 6 a further time, in that it is fed through the inlet filter 13 and/or through the filter module 3.

Furthermore, other reagents, which are provided in advance on the cartridge 1, can also be transferred by way of the inlet 4 into the sample input chamber 2 and for example mix with the sample 6.

Some of the reference signs explained in conjunction with FIG. 1 are repeated in the following figures to allow quick orientation, but sometimes then not explained again. Reference is made here respectively to the explanation (given by way of example) with reference to FIG. 1.

In FIGS. 2a and 2b, the sequence for filtering a sample 6 with the input into the sample input chamber 2 in the device 18 is shown. According to FIG. 2a, input takes place through a cover structure 10 into the sample input chamber 2. This takes place with the input means 11. Furthermore, the cover structure 10 ensures shielding of the sample with respect to the outside and a build-up of pressure in the first sub-volume v₁, which is used as a pressure chamber.

According to FIG. 2b, the sample 6 is filtered by the filter module 3. In this case, the sample 6 may be filtered for example on the basis of the size of its constituents and/or be homogenized by mechanical shearing and/or selective binding of certain constituents of the sample 6, such as for example proteins, may be realized by using a corresponding filter membrane (membrane/filter/mesh) of the filter module 3. In this case, the sample 6 enters the sub-volume v₂ of the sample input chamber 2 and can then be used for further processing.

FIGS. 3a to 3d show a combined sequence as an example for size filtration and subsequent homogenization of a sample with a described microfluidic system 1 or with its sample input chamber 2.

In FIG. 3a, the sample input chamber 2 is supplied with the sample 6 in a contamination-free manner by means of a syringe as input means 11 through the cover structure 10 configured as a pierceable membrane (for example a septum). Furthermore, the cover structure 10 ensures shielding of the sample 6 with respect to the outside.

In FIG. 3b, the sample 6 is filtered on the basis of the size of its constituents by the exchangeable, correspondingly chosen filter module 3 and enters the second sub-volume v₂. For example, the filtering out of larger constituents to be filtered out, such as for example clumps of blood, hair or other constituents, takes place here. Such constituents remain in the filter module 3.

In FIG. 3c, the filtered sample 6 in the sub-volume v₂ is transferred by way of the outlet 5 into the microfluidic system 16 (not shown here) on a cartridge 1. If appropriate, it can be fed back into the sample input chamber 2 or into the second sub-volume v₂ by way of an inlet 4.

In FIG. 3d, the sample 6 is homogenized by an inlet filter 13 at the inlet 4. Here, for example, cell clumps are individually separated. Repeated circulatory pumping leads to a completely homogenized sample 6 or sample liquid, which can be used for further processing in the microfluidic system 16 on the cartridge 1.

In FIGS. 4a to 4d, the filtering of a sample 6 with respect to its particle size and the subsequent mixing with a reagent provided in advance on the cartridge 1 are shown by way of example.

According to FIG. 4a, a cover structure 10 is disclosed, configured as a pierceable membrane (for example a septum). The sample input chamber 2 can be filled with the sample 6 in a contamination-free manner by means of input means 11 (for example a syringe). Furthermore, the cover structure 10 ensures shielding of the sample 6 with respect to the outside.

According to FIG. 4b, the sample 6 is filtered by the exchangeable, correspondingly chosen filter modules 3 on the basis of the size of its constituents and enters the second sub-volume v₂. Larger constituents to be filtered out are for example clumps of blood, hair or other constituents. Such constituents in this case remain on or at or in the filter module 3.

According to FIG. 4c, the sample 6 can be transferred into the microfluidic system 16 on the cartridge 1 through the outlet 5.

According to FIG. 4d, the inlet 4 of the sample input chamber 2 is used to mix the filtered sample with a mixing fluid 14 (a reagent) and then further process this sample mixture in the microfluidic system 16 on the cartridge 1.

1. A device for transferring a sample into a microfluidic system, comprising:
a sample input chamber, wherein
a first sub-volume of the sample input chamber is delimited from at least one second sub-volume of the sample input chamber by a filter module,
the first sub-volume forms a pressure chamber, configured as an input of the sample, and
at least one second sub-volume is configured to present the sample to the microfluidic system.

2. The device as claimed in claim 1, wherein the first sub-volume is adapted to the nature of the sample.

3. The device as claimed in claim 1, wherein the second sub-volume is greater than the first sub-volume.

4. The device as claimed in claim 1, wherein the second sub-volume has at least one outlet, which connects the second sub-volume to the microfluidic system.

5. The device as claimed in claim 1, wherein:
the sample input chamber has an input opening, which is sealed with respect to the surroundings by a fluid-tight cover structure; and
the fluid-tight cover structure is configured to be severed by an input means for the input of the sample such that contamination-free input of the sample into the sample input chamber takes place.

6. The device as claimed in claim 1, wherein the fluid-tight cover structure is configured such that a pressure can be built up in the first sub-volume by an input means.

7. The device as claimed in claim 6, wherein the filter module is of a multilayered configuration.

8. The device as claimed in claim 1, wherein the filter module is of an exchangeable design.

9. The device as claimed in claim 1, wherein the filter module is inserted in a receiving means in the sample input chamber.

10. The device as claimed in claim 1, wherein the sample input chamber has an inlet through which a fluid can be fed into the sample input chamber.

11. The device as claimed in claim 10, wherein the inlet is separated from the sample input chamber by an inlet filter.

12. A method for using a device as claimed in claim 1, comprising:
inputting a sample into the sample input chamber.

13. The method as claimed in claim 12, wherein, during the inputting, a sample sub-volume of the sample is fed through the filter module into the second sub-volume of the sample input chamber.

14. The method as claimed in claim 13, wherein, when the sample sub-volume passes through the filter module, a preparational treatment of the sample sub-volume for further processing in the microfluidic system takes place.

15. The method as claimed in claim 12, wherein, when the sample is input by the input means, a pressure greater than a maximum working pressure that can be provided by an automatable feeding means for the microfluidic system is provided.

16. The device as claimed in claim 2, wherein the nature of the sample is the expected particle content to be held back.
